(19) United States
(12) Patent Application Publication
(10) Pub. No.: US 2012/0206521 A1
(43) Pub. Date: Aug. 16, 2012

(54) LIQUID EJECTING APPARATUS AND CONTROL METHOD THEREFOR

(75) Inventor: Junhua Zhang, Shiojiri-shi (JP)

(73) Assignee: SEIKO EPSON CORPORATION, Shinjuku-ku (JP)

(21) Appl. No.: 13/397,629

(22) Filed: Feb. 15, 2012

(30) Foreign Application Priority Data
Feb. 15, 2011 (JP) 2011-029494

(51) Int. Cl. B41J 2/07

(52) U.S. Cl. 347/11

(57) ABSTRACT

A liquid ejecting apparatus includes an ejection unit which includes a pressure chamber and a pressure generation element, and which ejects the liquid through a nozzle of the pressure chamber in accordance with the variation of the pressure inside the pressure chamber; a driving signal generation section; a driving section which causes the liquid to eject through the nozzle by supplying the pressure generation element with an ejection waveform included in the driving signal, and which transmits a slight vibration to the liquid contained in the pressure chamber a plurality of number of times during the driving period of time by supplying the pressure generation element with a plurality of slight vibration waveforms which is included during the driving period of time of the driving signal.

The entire disclosure of Japanese Patent Application No: 2011-029494, filed Feb. 15, 2011 is expressly incorporated by reference herein.

### BACKGROUND

1. Technical Field

The present invention relates to technologies for ejecting liquid, such as ink.

2. Related Art

A typical recording head, which ejects ink contained in each of pressure chambers thereof by causing a pressure generation element thereof, such as a piezoelectric element or a heater element, to change a pressure inside the pressure chamber, reduces the rate of increase in viscosity of the ink contained in the pressure chamber by transmitting a slight vibration (i.e., a vibration causing agitation of the ink to a degree that does not eject the ink through a nozzle) to the ink contained in the pressure chamber. For example, in JP-A-2010-240952, a technology, in which two systems of a driving signal COMP and a driving signal COMA are used for ejections and slight vibrations of the ink contained in the pressure chamber, has been disclosed.

In each cycle of the driving signal COMP, an ejection pulse for ejecting ink contained in the pressure chamber and a slight vibration pulse for transmitting a slight vibration to the ink are included; while in each cycle of the driving signal COMA, a plurality of slight vibration pulses is included. During a printing period of time while images are printed on recording paper, the ejection pulse or the slight vibration pulse included in each cycle of the driving signal COMP is selectively supplied to the pressure generation element; while during periods of time other than the printing period of time (in the case where an environmental temperature is low), the slight vibration pulses included in each cycle of the driving signal COMA are supplied to the pressure generation element.

Meanwhile, for example, in order to realize high-density arrays of nozzles of a recording head, it is necessary to downsize each of pressure chambers. However, in a configuration in which each of the pressure chambers is downsized, the increase in viscosity of ink contained in the pressure chamber proceeds during a short period of time, and, for example, the increase in viscosity of ink is likely to proceed during such a short period of time as a period of time while the recording head reciprocates once over the surface of recording paper. Therefore, even though a technology disclosed in JP-A-2010-240952, in which, during a printing period of time, a slight vibration is transmitted to the ink contained in the pressure chamber once for each cycle of the driving signal COMP, is employed, the rate of increase of viscosity of the ink is likely not to be effectively reduced because of insufficient agitation of the ink. Furthermore, the necessity of the two systems of the driving signal COMP, which is used during a printing period of time, and the driving signal COMA, which is used during each of periods of time other than the printing period of time, leads to a disadvantage in that loads on processes, such as a process of generating the driving signals, and a process of appropriately selecting the driving signals to drive the pressure generation element, are large.

### SUMMARY

Accordingly, an advantage of some aspects of the invention is to provide a liquid ejecting apparatus and a method therefor which enable effective reduction of the rate of increase in viscosity of liquid contained in each of pressure chambers in a simple configuration.

A liquid ejecting apparatus according to a first aspect of the invention includes an ejection unit which includes a pressure chamber filled with liquid (for example, ink) and a pressure generation element causing a pressure inside the pressure chamber to vary, and which ejects the liquid through a nozzle of the pressure chamber in accordance with the variation of the pressure inside the pressure chamber; a driving signal generation section which generates a driving signal whose electric potential varies with a cycle of a driving period of time; and a driving section which causes the liquid to eject through the nozzle by supplying the pressure generation element with an ejection waveform included in the driving signal, and which transmits a slight vibration to the liquid contained in the pressure chamber a plurality of number of times during the driving period of time by supplying the pressure generation element with a plurality of slight vibration waveforms (for example, slight vibration pulses PVs) which is included during the driving period of time of the driving signal.

In the above-described configuration, a plurality of slight vibrations is transmitted to the liquid contained in the pressure chamber during the driving period of time of the driving signal, and thus, this configuration enables effective reduction of the rate of increase in viscosity of the liquid contained in the pressure chamber. Further, an ejection waveform and a plurality of slight vibration waveforms included in a system of the driving signal are selectively supplied to the pressure generation element, and thus, this configuration leads to an advantage in that it is possible to simplify a method for generating the driving signals, as well as a method for supplying the driving signals to the pressure generation element, the methods being performed by the driving signal generation section, compared with a configuration in which two systems of driving signals are needed. In addition, the number of slight vibrations is counted in such a way that a pair of a pressurization operation and a depressurization operation of the pressure chamber, which are performed by the pressure generation element, is treated as a unit of vibrations (i.e., a vibration which causes once). Moreover, it is to be noted that the above-described non-necessity of the two systems of driving signals is not intended to exclude a configuration, in which the two systems of driving signals are used in driving operations of the driving section, from the scope of the invention.

In a first variation of the first aspect, each of the plurality of slight vibration waveforms may be a waveform which is made different from the ejection waveform, so that this configuration leads to an advantage in that the shape of each of the slight vibration waveforms can be determined more flexibly (that is, each of the slight vibration waveforms can be determined independently of the waveform of the ejection waveform so that slight vibrations each having a desired characteristic can be transmitted to the liquid contained in the pressure chamber), compared with a configuration (a second variation of the first aspect, which will be described below), in which part of the ejection waveform is applied as each of the slight vibration waveforms. In addition, a specific example of the first variation will be hereinafter described as, for example, a first embodiment.

In a specific example of the first variation, the driving signal includes a first slight vibration waveform and a second slight vibration waveform as the plurality of slight vibration waveforms during every driving period of time, and the ejection waveform is located between the first slight vibration waveform and the second slight vibration waveform. Further, in another specific example of the first variation, the driving signal includes a plurality of ejection waveforms and a plurality of slight vibration waveforms during every driving period of time, and the ejection waveforms and the slight vibration waveforms are alternately located. In each of the above-described examples of the first variation, any two successive slight vibration waveforms are mutually distantly located so as to interpose an ejection waveform therebetween, and thus, this configuration leads to an advantage in that it is possible to effectively utilize the slight vibrations each including a damping process thereof, which are transmitted to the liquid through the plurality of slight vibration waveforms, (accordingly, it is possible to effectively reduce the rate of increase in viscosity of the liquid).

In a second variation of the first aspect, the driving section may supply the pressure generation element with part of intervals of the ejection waveform included in the driving signal as at least one of the plurality of slight vibration waveforms. In this second variation, part of intervals of the ejection waveform is applied as at least one of the slight vibration waveforms, and thus, this configuration leads to an advantage in that the time length of the driving period of time is made shorter compared with that of the first variation, in which the plurality of slight vibration waveforms are determined independently of the ejection waveform. In addition, a specific example of the second variation will be hereinafter described as, for example, a second embodiment.

In a specific example of the second variation, the ejection waveform includes a first variation element, during which an electric potential varies in a first direction starting from a reference electric potential; a first intermediate element, during which, after having varied along the first variation element, the electric potential varies in a second direction opposite to the first direction to an intermediate electric potential; a second intermediate element, during which, after having varied along the first intermediate element, the electric potential varies in the second direction; and a second variation element, during which, after having varied along the second intermediate element, the electric potential varies in the first direction to the reference electric potential. Further, the driving section supplies the pressure generation element with an interval corresponding to the elements of the ejection waveform, which are located prior to a start point of the second intermediate element, as a first slight vibration waveform of the plurality of slight vibration waveforms.

In a more preferred example of the second variation, a second slight vibration waveform of the plurality of slight vibration waveforms, which is supplied to the pressure generation element after the supply of the first slight vibration waveform, includes a third variation element, during which an electric potential varies in the first direction from the intermediate electric potential, and a fourth variation element, during which, after having varied along the third variation element, the electric potential varies in the second direction. In this example, the termination point of the first slight vibration waveform and the start point of the second vibration waveform are set to the same electric potential (an intermediate electric potential), and thus, this configuration enables the electric potential applied to the pressure generation element to vary continuously at points prior to and subsequent to the start point of the second slight vibration waveform. Accordingly, this configuration leads to an advantage in that it is possible to prevent occurrence of a situation in which an unexpected vibration is transmitted to the ink contained in the pressure chamber at the start point of the second slight vibration. Furthermore, in a configuration in which the intermediate electric potential is an electric potential of a point shifted in the second direction (for example, to a lower electric potential side) from the reference electric potential, it is possible to make electric-potential variation amounts of the first vibration waveform and the second vibration waveform be more, compared with a configuration in which the intermediate electric potential is set to an electric potential equal to the reference electric potential, or is set to an electric potential of a point shifted in the first direction from the reference electric potential. Accordingly, in this case, there is an advantage in that it is possible to sufficiently ensure the intensity of each of the slight vibrations transmitted to the liquid contained in the pressure chamber.

The invention is also specified as a control method for a liquid ejecting apparatus associated with the above-described cases according to the first aspect. A control method for a liquid ejecting apparatus, according to a second aspect of the invention, is a control method for a liquid ejecting apparatus which includes a pressure chamber filled with liquid and a pressure generation element causing a pressure inside the pressure chamber to vary, and which ejects the liquid through a nozzle of the pressure chamber in accordance with the variation of the pressure inside the pressure chamber. Further, the control method includes generating a driving signal whose electric potential varies with a cycle of a driving period of time; ejecting the liquid through the nozzle by supplying the pressure generation element with an ejection waveform included in the driving signal; and transmitting a slight vibration to the liquid contained in the pressure chamber a plurality of number of times during the driving period of time by supplying the pressure generation element with a plurality of slight vibration waveforms included in the driving signal during the driving period of time. The above-described control method also realizes behaviors and effects the same as or similar to those of the liquid ejecting apparatus according to the first aspect of the invention.

### BRIEF DESCRIPTION OF THE DRAWINGS

The invention will be described with reference to the accompanying drawings, wherein like numbers reference like elements.

FIG. 1 is a schematic diagram partially illustrating a printing apparatus according to a first embodiment of the invention.

FIG. 2 is a diagram illustrating a configuration of a recording head according to a first embodiment of the invention.

FIG. 3 is a block diagram illustrating an electric configuration of a printing apparatus according to a first embodiment of the invention.

FIGS. 4A, 4B and 4C are diagrams illustrating a waveform of a driving signal and an electric potential supplied to a piezoelectric element, according to a first embodiment of the invention.

FIGS. 5A, 5B and 5C are diagrams illustrating a waveform of a driving signal and an electric potential supplied to a piezoelectric element, according to a second embodiment of the invention.

FIGS. 6A and 6B are diagrams each illustrating a waveform, which are used for description of an effect of a second embodiment of the invention.

FIG. 7 is a diagram illustrating a waveform of a driving signal in a modification example 1 of embodiments according to the invention.

FIGS. 8A and 8B are diagrams each illustrating a waveform of a driving signal in a modification example 2 of embodiments according to the invention.

### DESCRIPTION OF EXEMPLARY EMBODIMENTS

### A: First Embodiment

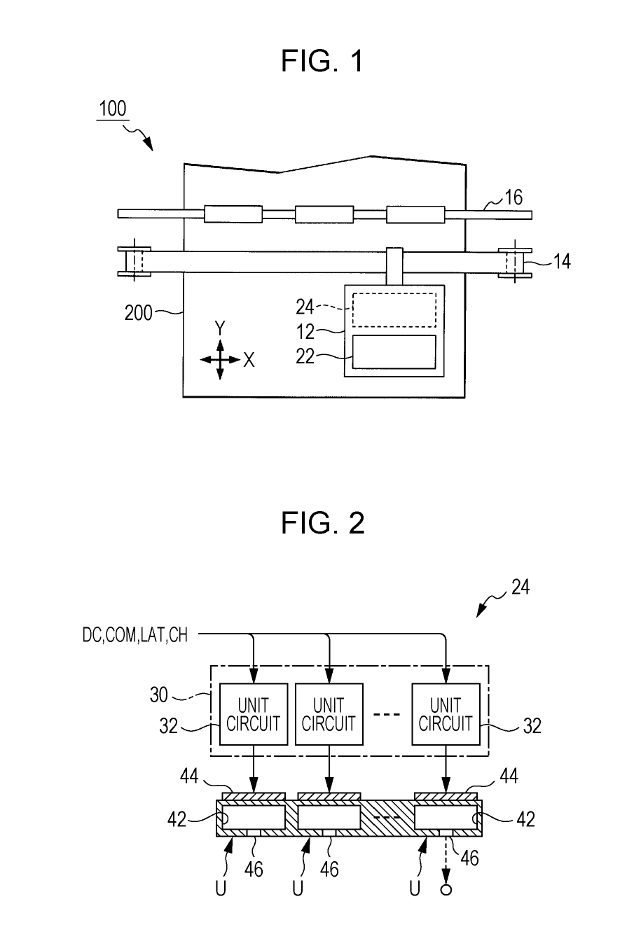

Referring to FIG. 1 which is a schematic diagram partially illustrating an ink jet type printing apparatus 100 according to a first embodiment of the invention, the printing apparatus 100 is a liquid ejecting apparatus configured to eject droplets of ink onto recording paper 200, and is equipped with a carriage 12, a moving mechanism 14 and a paper transporting mechanism 16.

The carriage 12 includes an ink cartridge 22 and a recording head 24 mounted thereon. The ink cartridge 22 is a reservoir for storing ink (liquid) which is ejected onto the recording paper 200. The recording head 24 functions as a liquid ejection unit configured to eject ink, which is supplied from the ink cartridge 22, onto the recording paper 200. In addition, it is also possible to adopt a configuration (an off-carriage method) in which the recording head 24 is supplied with ink from the ink cartridge 22 which is attached to the body (omitted from illustration) of the printing apparatus 100.

The moving mechanism 14 reciprocates the carriage 12 in an X-direction (in a main-scanning direction). The position of the carriage 12 is detected by a detector (omitted from illustration), such as a linear encoder, and is utilized for control of the moving mechanism 14. The paper transporting mechanism 16 transports the recording paper 200 in a Y-direction (in a sub-scanning direction) in conjunction with reciprocation of the carriage 12. During the reciprocation of the carriage 12, the printing apparatus 100 causes the recording head 24 to eject ink onto the recording paper 200, so that desired images are recorded (printed) on the recording paper 200.

Referring to FIG. 2 which is a schematic diagram illustrating the recording head 24, the recording head 24 is equipped with a plurality of ejection units Us arrayed in the Y-direction of FIG. 1, and a driving circuit 30 configured to drive each of the ejection units Us. Each of the plurality of ejection units Us is an element which functions as a unit of an overall ink ejecting operation, and includes a pressure chamber 42 and a piezoelectric element 44. The pressure chamber 42 is a space in which ink supplied from the ink cartridge 22 is contained, and has a nozzle 46 (a through-hole) formed on a side wall opposite to the surface of the recording paper 200. The nozzles 46 of the respective ejection units Us are arrayed in a straight-line configuration or in a zigzag configuration in the Y-direction. The piezoelectric element 44 of each of the ejection units Us vibrates in accordance with an electric potential supplied from the driving circuit 30. In the following description, a configuration, in which the piezoelectric element 44 reduces pressure inside the pressure chamber 42 in accordance with a variation of the electric potential, which is supplied from the driving circuit 30, in a positive electric potential direction (i.e., to a higher electric potential side); while the piezoelectric element 44 increases pressure inside the pressure chamber 42 in accordance with a variation of the electric potential, which is supplied from the driving circuit 30, in a negative electric potential direction (i.e., to a lower electric potential side). The variation of pressure inside the pressure chamber 42, which is made by the piezoelectric element 44, causes the ink contained in the pressure chamber 42 to eject through the nozzle 46.

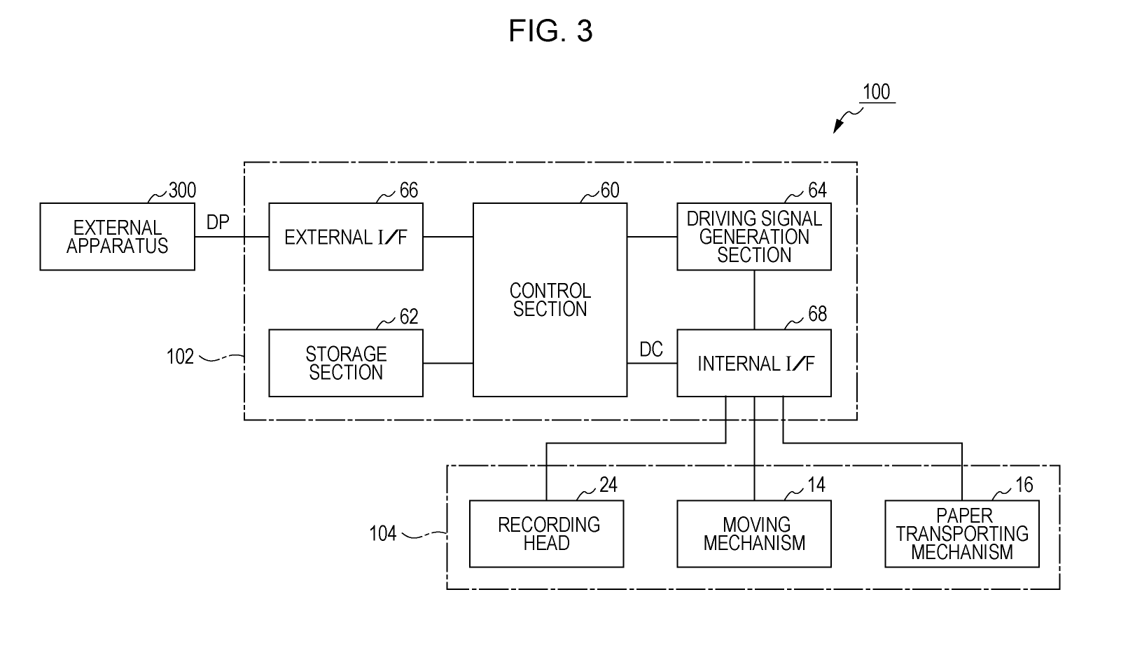

Referring to FIG. 3 which is a block diagram illustrating an electric configuration of the printing apparatus 100, the printing apparatus 100 is equipped with a control apparatus 102 and a print processing section (a print engine) 104. The print processing section 104 is an element configured to record images on the recording paper 200, and includes the recording head 24, the moving mechanism 14 and the paper transporting mechanism 16, which have been described above. The control apparatus 102 is an element configured to perform control of the print processing section 104, and includes a control section 60, a storage section 62, a driving signal generation section 64, an external I/F 66 (interface), and an internal I/F 68. The external I/F 66 is supplied with print data DP from an external apparatus 300 (for example, a host computer), the print data DP representing images to be printed on the recording paper 200; while the internal I/F 68 is connected to the print processing section 104.

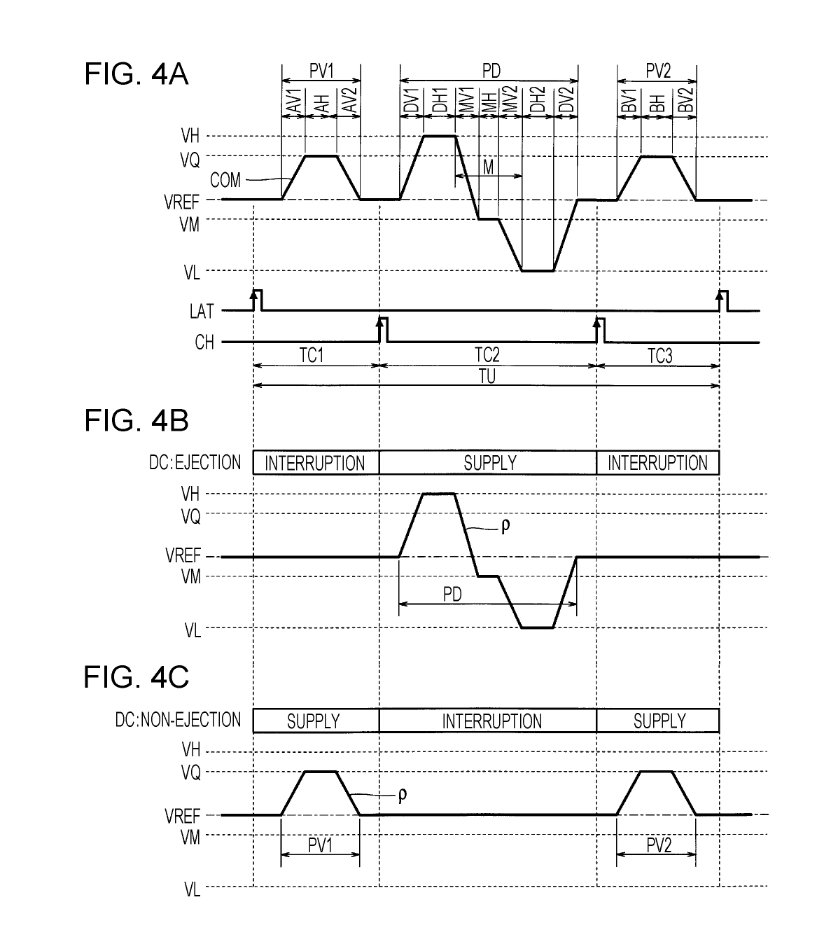

The driving signal generation section 64 generates a driving signal COM shown in FIG. 4A, which is used for driving the piezoelectric element 44. As shown in FIG. 4A, the driving signal COM is a voltage signal which has a cycle of a driving period of time TU of a predetermined length, and which has an electric potential varying in a higher electric potential direction and in a lower electric potential direction relative to a predetermined reference electric potential VREF. The driving period of time TU corresponds to a temporal unit during which one dot is formed on the recording paper 200. The driving period of time TU is segmented into a plurality of control periods of time TCs (TC1, TC2 and TC3).

As shown in FIG. 4A, during each of the driving period of time TUs of the driving signal COM, one ejection pulse PD and two slight vibration pulses PVs (PV1 and PV2) are located. Specifically, the slight vibration pulse PV1, the ejection pulse PD and the slight vibration pulse PV2 are located during the control periods of time TC1, TC2 and TC3, respectively. That is, the ejection pulse PD is located between the slight vibration pulses PV1 and PV2. When having been supplied with the ejection pulse PD, the piezoelectric element 44 vibrates the pressure chamber 42 so as to cause a predetermined amount of ink to be ejected through the nozzle 46. Meanwhile, when having been supplied with the slight vibration pulse PV1 or PV2, the piezoelectric element 44 is allowed to transmit a vibration to ink contained in the pressure chamber 42 to a degree that does not cause the ink to be ejected through the nozzle 46 (hereinafter, such a vibration will be called “a slight vibration”). As a result, an agitation caused by the slight vibration reduces the rate of increase in viscosity of the ink contained in the pressure chamber 42.

As shown in FIG. 4A, the ejection pulse PD forms an ejection waveform resulting from junction of a variation element DV1, a retention element DH1, a transition element M, a retention element DH2, and a variation element DV2 in the same order as that of these elements listed above. The variation element DV1 is an interval during which an electric potential varies with a predetermined gradient in a positive direction from the reference electric potential VREF to an electric potential VH (i.e., in a direction along which the pressure inside the pressure chamber 42 decreases). During an interval corresponding to the retention element DH1, the electric potential VH of the termination point of the variation element DV1 is retained.

The transition element M is an interval during which the electric potential varies in a negative direction from the electric potential VH of the termination point of the retention element DH1 (the termination point of the variation element DV1) to an electric potential VL across the reference electric potential VREF (i.e., in a direction along which the pressure inside the pressure chamber 42 increases). During an interval corresponding to the retention element DH2, the electric potential VL of the termination point of the transition element M is retained. During an interval corresponding to the variation element DV2, the electric potential varies with a predetermined gradient in the positive direction from the electric potential VL to the reference electric potential VREF.

The transition element M forms a waveform resulting from junction of an intermediate element MV1, a retention element MH and an intermediate element MV2 in the same order as that of these elements listed above. During an interval corresponding to the intermediate element MV1, the electric potential varies with a predetermined gradient in the negative direction from the electric potential VH of the termination point of the retention element DH1 to an intermediate electric potential VM. The intermediate electric potential VM is a predetermined electric potential lower than the reference electric potential VREF. During an interval corresponding to the retention element MH, the intermediate electric potential VM of the termination point of the intermediate element MV1 is retained. During an interval corresponding to the intermediate element MV2, the electric potential varies with a predetermined gradient in the negative direction from the intermediate electric potential VM to an electric potential VL.

As shown in FIG. 4A, the slight vibration pulse PV1 is formed in a trapezoidal shape resulting from junction of a variation element AV1, a retention element AH and a variation element AV2 in the same order as that of these elements listed above. The variation element AV1 is an interval during which the electric potential varies with a predetermined gradient in the positive direction from the reference electric potential VREF to a predetermined electric potential VQ. During an interval corresponding to the retention element AH, the electric potential VQ of the termination point of the variation element AV1 is retained. During an interval corresponding to the variation element AV2, the electric potential varies with a predetermined gradient in the negative direction from the electric potential VQ of the termination point of the retention element AH (the termination point of the variation element AV1) to the reference electric potential VREF. Just like the slight vibration pulse PV1, the slight vibration pulse PV2 is also formed in a trapezoidal shape resulting from junction of a variation element BV1 corresponding to an interval during which the electric potential varies from the reference electric potential VREF to the electric potential VQ, a retention element BH corresponding to an interval during which the electric potential VQ is retained, and a variation element BV2 corresponding to an interval during which the electric potential varies from the electric potential VQ to the reference electric potential VREF.

The storage section 62 shown in FIG. 3 includes ROM modules configured to store control programs and the like, and RAM modules configured to temporarily store various data. The control section 60 performs overall control of individual elements (for example, the print processing unit 104) when executing the control programs stored in the storage section 62. For example, the control section 60 generates control data DC, which indicates an operation (i.e., an ejection of ink or a non-ejection of ink) for each of the ejection units Us, from the print data DP for each driving period of time TU.

The driving circuit 30 of the recording head 24, which is shown in FIG. 2, includes a plurality of unit circuits 32 corresponding to the respective ejection units Us. The driving signal COM generated by the driving signal generation section 64 and the control data DC generated by the control section 60 are supplied to each of the plurality of unit circuits 32 via the internal I/F 68. Further, each of the unit circuits 32 is supplied with a latch pulse LAT and a control pulse (a channel signal) CH, which are shown in FIG. 4A, from the control apparatus 102. The latch pulse LAT is generated so as to rise up in synchronization with a start point of each of the driving periods of time TUs (i.e., a start point of the control period of time TC1). Further, the control pulses CHs are generated so as to rise up in synchronization with a start point of the control period of time TC2 and a start point of the control period of time TC3, respectively. That is, the control periods of time TC1, TC2 and TC3 existing during each of the driving periods of time TUs are determined by a pair of the latch pulse LAT and the control pulse CH, a pair of the two control pulses CHs, and a pair of the control pulse CH and the latch pulse LAT, respectively.

Each of the unit circuits 32 reads in the control data DC corresponding to itself in synchronization with the latch pulse LAT which is supplied at a start point of the driving period of time TU. Further, during each of the plurality of control periods of time TCs (TC1, TC2 and TC3) within the driving period of time TU, the unit circuit 32 performs control so as to supply the driving signal COM to the piezoelectric element 44, or so as not to supply the driving signal COM to the piezoelectric element 44, in accordance with the read-in control data. That is, any combination of at least one control period of time, which is selected from among the plurality of control periods of time TCs within the driving period of time TU, and which includes therewithin the driving signal COM supplied to the piezoelectric element 44, can be obtained flexibly in accordance with the control data DC. In addition, during any control period of time while the supply of the driving signal COM is halted, the piezoelectric element 44, which functions as a capacitor, retains an electric potential of a point immediately prior to the start point of the control period of time.

Specifically, if the control data DC, which has been read in at a start point of the driving period of time TU, indicates an ejection of ink, as shown in FIG. 4B, the unit circuit 32 supplies the driving signal COM (an ejection pulse PD) to the piezoelectric element 44 during the control period of time TC2 within the driving period TU, and halts the supply of the driving signal COM to the piezoelectric element 44 during the control periods of time TC1 and TC3 therewithin. Therefore, as denoted by a symbol p in FIG. 4B, the supply of the ejection pulse PD included in the driving signal COM to the piezoelectric element 44 during the control period of time TC2 causes the ink contained in the pressure chamber 42 to be ejected onto the recording paper 200.

Meanwhile, if the control data, which has been read in at a start point of the driving period of time TU, indicates no ejection of ink (i.e., a transmission of a slight vibration), as shown in FIG. 4C, the unit circuit 32 supplies the driving signal COM to the piezoelectric element 44 during the control periods of time TC1 and TC3 within the driving period of time TU, and halts the supply of the driving signal COM to the piezoelectric element 44 during the control period of time TC2 therewithin. Therefore, as denoted by a symbol p in FIG. 4C, the slight vibration pulses PV1 and PV2 included in the driving signal COM, which are supplied to the piezoelectric element 44 during the control periods of time TC1 and TC2, transmit slight vibrations to the ink contained in the pressure chamber 42, respectively. That is, according to the first embodiment, the ink contained in each of the pressure chambers 42 of the respective ejection units Us, which are controlled so as not to eject the ink, is subjected to transmission of a slight vibration twice during the driving period of time TU.

Downsizing of each of the pressure chambers 42 to realize high-density arrays of the nozzles 46 included in the recording head 24 increases viscosity of ink contained in each of the pressure chamber 42 with a higher rate. Therefore, a configuration, in which a slight vibration is transmitted only once during the driving period of time TU (hereinafter, this configuration will be called “a comparison example 1”), is likely not to effectively reduce the rate of increase in viscosity of the ink contained in each of the pressure chambers 42. According to the first embodiment, a slight vibration is transmitted a plurality of number of times during one of the driving periods TUs (that is, a cycle with which a slight vibration is transmitted is made shorter compared with that of the comparison example 1), and thus, even in the case where each of the pressure chambers 42 is downsized, there is an advantage in that it is possible to reduce the rate of increase in viscosity of the ink contained in each of the pressure chambers 42 more effectively, compared with that of the comparison example 1. In other words, it is possible to, along with sufficiently keeping the effect of reducing the rate of increase in viscosity of ink contained in each of the pressure chambers 42, achieve high-density arrays of the nozzles 46 (for example, more than 300 dpi) by downsizing each of the pressure chambers 42.

Moreover, the provision of the ejection pulse PD and the two slight vibration pulses PVs (PV1 and PV2) during the driving period of time TU of a system of the driving signal COM simplifies a process in which the driving signal generation section 64 generates the driving signal COM, and a process in which the driving circuit 30 supplies the piezoelectric elements 44 with the driving signal COM, compared with the configuration disclosed in JP-A-2010-240952, in which two systems of driving signals, one being used for ejecting ink, the other one being used for transmitting slight vibrations, are necessary. That is, according to the first embodiment, it is possible to effectively reduce the rate of increase in viscosity of ink contained in the pressure chamber 42 in a simple configuration.

Further, a configuration which enables increase of the intensity of the slight vibration by increasing a variation amount of an electric potential (a wave height value) associated with a slight vibration pulse, can be also conceived. However, an excessive variation of a pressure inside the pressure chamber 42 due to increase of the intensity of the slight vibration is likely to cause the ink contained in the pressure chamber 42 to be erroneously ejected through the nozzle 46. According to the first embodiment, even in the case where the intensity of the slight vibration is limited to an extent that can sufficiently prevent the erroneous ejection, the transmission of a plurality of slight vibrations during the driving period of time TU achieves a sufficient agitation of the ink contained in the pressure chamber 42, and thus, also leads to an advantage in that it is possible to effectively reduce the rate of increase in viscosity of ink contained in the pressure chamber 42, along with preventing erroneous ejections of the ink contained therein.

In addition, it is possible to arbitrarily determine an order in which the ejection pulse PD and the plurality of the slight vibration pulses PVs (PV1 and PV2) are to be disposed. For example, it is also possible to locate mutually adjacent slight vibration pulses PV1 and PV2 anterior to or posterior to the ejection pulse PD. In this regard, however, in a configuration in which an interval between the slight vibration pulses PV1 and PV2 is significantly short, a vibration transmitted by the slight vibration pulse PV1 and a vibration transmitted by the slight vibration pulse PV2 are likely to be mutually erased because a vibration, which is transmitted to the ink by the slight vibration pulse PV2, starts before a vibration, which is transmitted to the ink by the slight vibration pulse PV1, has perfectly disappeared. According to the first embodiment, the ejection pulse PD is located between the slight vibration pulses PV1 and PV2. That is, it is possible to keep an interval between the slight vibration pulses PV1 and PV2 with certainty. In this configuration, a vibration, which is transmitted to the ink by the slight vibration pulse PV2, starts after a vibration which is transmitted to the ink by the slight vibration pulse PV1, has perfectly disappeared, so that it is possible to effectively utilize the slight vibration of the ink contained in the pressure chamber 42, which has been transmitted by the slight vibration pulse PV1, including the process of damping of the slight vibration. Therefore, according to the first embodiment, there is an advantage in that it is possible to reduce the rate of increase in viscosity of ink contained in the pressure chamber 42 more sufficiently, compared with the configuration in which the slight vibration pulses PV1 and PV2 are located adjacent to each other (for example, a configuration in which any ejection pulse PD does not intervene between the slight vibration pulses PV1 and PV2).

### B: Second Embodiment

A second embodiment according to the invention will be hereinafter described. In the first embodiment, by providing one ejection pulse PD and two slight vibration pulses PVs (PV1 and PV2) during the driving period of time TU of the driving signal COM, a slight vibration is transmitted twice during the driving period of time TU. In this second embodiment, by applying part of the ejection pulse PD within the driving period of time TU of the driving signal COM as the slight vibration pulse PV (PV1), a slight vibration is transmitted a plurality of number of times (twice) to the ink during the driving period of time TU. In addition, in individual configuration examples which will be shown below, elements each having a behavior or a function which is equivalent to that of the first embodiment will be arbitrarily omitted from detailed description by applying reference symbols having been used in the descriptions above to the elements.

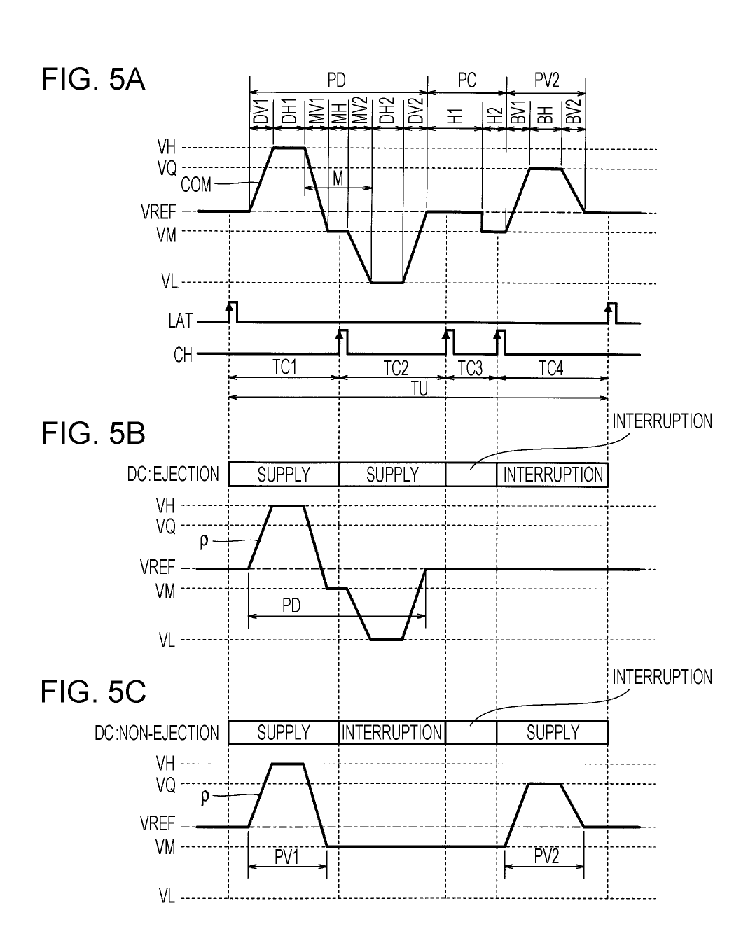

Referring to FIGS. 5A, 5B and 5C which are diagrams illustrating operations of the printing apparatus 100 according to the second embodiment, the driving signal COM according to the second embodiment includes the ejection pulse PD, a combination element PC and the slight vibration pulse PV2. The ejection pulse PD forms a waveform resulting from combination of the variation element DV1, the retention element DH1, the transition element M, the retention element DH2 and the variation element DV2 just like in the case of the first embodiment. Further, the transition element M of the ejection pulse PD is configured by the intermediate element MV1 which varies from the electric potential VH to the intermediate electric potential VM, the retention element MH which retains the intermediate electric potential VM, and the intermediate element MV2 which varies from the intermediate electric potential VM to the electric potential VL. A gradient of an electric potential variation during an interval corresponding to the intermediate element MV1, a gradient of an electric potential variation during an interval corresponding to the intermediate element MV2, a time length of an interval corresponding to the retention element MH, and an intermediate electric potential VM are selected so that a predetermined amount of ink contained in the pressure chamber 42 can be ejected with a predetermined rate. In the second embodiment, it is assumed that the intermediate electric potential VM is lower than the reference electric potential VREF just like in the case of the first embodiment.

The combination element PC is an interval which intervenes between the ejection pulse PD and the slight vibration pulse PV2 to combine them. Further, as shown in FIG. 5A, the combination element PC is formed so as to have a waveform resulting from combination of a retention element H1 and a retention element H2. During an interval corresponding to the retention element H1, the reference electric potential VREF of the termination point of the ejection pulse PD (the termination point of the variation element DV2) is retained. During an interval corresponding to the retention element H2, the intermediate electric potential VM, which is equivalent to an electric potential of the retention element MH of the ejection pulse PD, is retained. That is, during a transition from the retention element H1 to the retention element H2, the electric potential varies from the reference electric potential VREF to the intermediate electric potential VM. During an interval corresponding to the combination element PC, a period of time while the electric potential varies from the reference electric potential VREF to the intermediate electric potential VM (i.e., a period of time between the retention element H1 and the retention element H2) is sufficiently short in time length.

Just like in the first embodiment, the slight variation pulse PV2 forms a waveform resulting from combination of the variation element BV1, the retention element BH and the variation element BV2. In addition, as shown in FIG. 5A, during an interval corresponding to the variation element BV1, an electric potential varies from the intermediate electric potential VM of the termination point of the combination element PC (the termination point of the retention element H2) to an electric potential VQ. As described above, the driving signal COM according to the second embodiment does not include the slight vibration pulse PV1 independently.

As shown in FIG. 5A, just like in the case of the first embodiment, the latch pulse LAT supplied to each of the unit circuits 32 determines the driving period of time TU. Further, the control pulse CH is generated so as to segment the driving period of time TU into four control periods of time TCs (TC1, TC2, TC3 and TC4). Specifically, a first control pulse existing during the driving period of time TU determines an intermediate point of an interval corresponding to the retention element MH as a start point of the control period of time TC2. Moreover, a second control pulse CH and a third control pulse CH existing during the driving period of time TU determine an intermediate point of an interval corresponding to the retention element H1 existing during an interval corresponding to the combination element PC and an intermediate point of an interval corresponding to the retention element H2 existing during an interval corresponding to the combination element PC as a start point of a third control period of time and a start point of a fourth control period of time, respectively.

In the case where the control data DC indicates an ejection of ink, as shown in FIG. 5B, the unit circuit 32 supplies the driving signal COM to the piezoelectric element 44 during the control periods of time TC1 and TC2 within the driving period of time TU, and halts the supply of the driving signal COM to the piezoelectric element 44 during the control periods of time TC3 and TC4 therewithin. Therefore, as denoted by a symbol p of FIG. 5B, the ejection pulse PD existing from the control period of time TC1 to the control period of time TC2 is supplied to the piezoelectric element 44; thereby causing the ink contained in the pressure chamber 42 to be ejected onto the recording paper 200 just like in the case of the first embodiment.

Meanwhile, in the case where the control data indicates a non-ejection of ink, as shown in FIG. 5C, the unit circuit 32 supplies the driving signal COM to the piezoelectric element 44 during the periods of time TC1 and TC4 within the driving period of time TU, and halts the supply of the driving signal COM to the piezoelectric element 44 during the control periods of time TC2 and TC3 therewithin. Therefore, as denoted by a symbol p of FIG. 5C, during the control period of time TC1, a waveform resulting from combination of the variation element DV1, the retention element DH1 and the intermediate element MV1 of the ejection pulse PD is supplied to the piezoelectric element 44 as the slight vibration pulse PV1. That is, part of the intervals of the ejection pulse PD (i.e., the intervals DV1, DH1 and MV1) are applied as the slight vibration pulse PV1. Further, the slight vibration pulse PV2 is supplied to the piezoelectric element 44 during the control period of time TC4 just like in the case of the first embodiment. In addition, as described above, the piezoelectric element 44, which functions as a capacitor, retains an electric potential of the termination point of the slight vibration pulse PV1 during the control periods of time TC2 and TC3.

As described above, in the second embodiment, just like in the first embodiment, the supply of the slight vibration pulses PV1 and PV2 transmits a sight vibration twice to ink contained in the pressure chamber 42 included in each of the ejection units Us which are controlled so as not to eject the ink. Therefore, the same effect as that of the first embodiment can be also realized in the second embodiment.

Moreover, in the second embodiment, it is unnecessary for the driving signal COM to include the slight vibration pulse PV1 independently of the ejection pulse PD because part of the intervals of the ejection pulse PD (i.e., the intervals DV1, DH1 and MV1) are supplied to the piezoelectric element 44 as the slight vibration pulse PV1. Therefore, the time length of the driving period of time TU (i.e., the time length of a period of time during which each ejection unit U ejects ink) is made shorter compared with that of the first embodiment in which the driving signal includes the two slight vibration pulses PV1 and PV2 independently of the ejection pulse PD, and this leads to an advantage in that high-speed recording of images onto the recording paper 200 can be realized. In addition, in the first embodiment in which the slight vibration pulses PVs are provided independently of the ejection pulse PD, there is an advantage in that it is possible to select waveforms of the respective slight vibration pulses independently of the ejection pulse PD so that slight vibrations each having a desired characteristic can be transmitted to the ink contained in each of the pressure chambers 42.

In the second embodiment 2, the electric potential of the termination point of the intermediate element MV1 included in the ejection pulse PD (the electric potential of the termination point of the slight vibration pulse PV1) and the electric potential of the start point of the slight vibration pulse PV2 are set to the intermediate electric potential VM which is lower than the reference electric potential VREF. Therefore, compared with a configuration in which the electric potentials of the termination point of the intermediate element MV1 and the start point of the slight vibration pulse PV2 are higher than or equal to the reference electric potential VREF (hereinafter, this configuration will be called “a comparison example 2”), the variation amount (amplitude) of an electric potential of each of the slight vibration pulses PV1 and PV2 according to the second embodiment 2 is made larger. That is, it is possible to increase the intensity of each of the slight vibrations transmitted to the ink contained in the pressure chamber 42, compared with that of the comparison example 2.

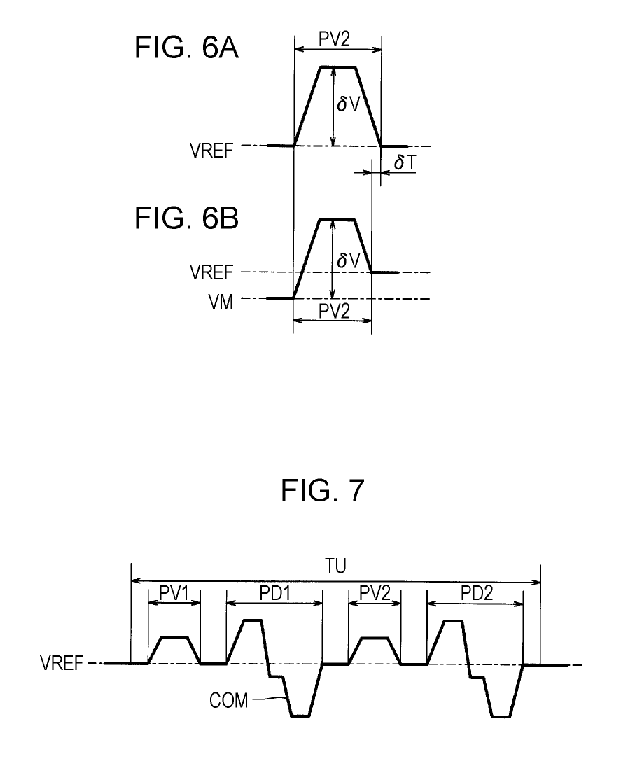

Referring to FIGS. 6A and 6B, which are comparison diagrams illustrating the slight vibration pulse PV2 according to the first embodiment, and the slight vibration pulse PV2 according to the second embodiment, respectively, both of the start point and the termination point of the slight vibration pulse PV2 according to the first embodiment are set to the reference electric potential VREF; while the start point of the slight vibration pulse PV2 according to the second embodiment is set to the intermediate electric potential VM. If the variation amount (amplitude) 6V and the gradient of an electric potential are made common to the slight vibration pulse PV2 according to the first embodiment and the slight vibration pulse PV2 according to the second embodiment, as shown in FIGS. 6A and 6B, the pulse width of the slight vibration pulse PV2 according to the second embodiment is made shorter by a time length 8T, compared with that of the slight vibration pulse PV2 according to the first embodiment. A situation of the slight vibration pulse PV1 is similar to the above-described situation of the slight vibration pulse PV2. As described above, a configuration, in which the electric potentials of the slight vibration pulses PV1 and PV2 are set to the intermediate electric potential VM which is lower than the reference electric potential VREF, also makes a contribution to the effect in which the time length of the driving period of time TU (i.e., the time length of a period of time during which each ejection unit U ejects ink) is made shorter.

In addition, an excessively rapid variation of an electric potential supplied to the piezoelectric element 44 is likely to transmit an excessive vibration to the ink contained in the pressure chamber 42. Therefore, it is necessary to limit the gradient of the electric potential supplied to the piezoelectric element 44 to within a range which allows an appropriate vibration to be transmitted to the ink. Meanwhile, as understood from the foregoing description, since, regardless of whether the ejection unit U ejects ink, or not, any electric potential is not supplied to the piezoelectric element 44 during a boundary interval between the retention elements H1 and H2 of the combination element PC according to the second embodiment, even in the case where the electric potential of the retention element H1, which is equal to the reference electric potential VREF, rapidly varies to the electric potential of the retention element H2, which is equal to the intermediate electric potential VM, any excessive vibration is not transmitted to the ink contained in the pressure chamber 42. Therefore, causing the electric potential of the driving signal COM to vary sufficiently rapidly during the boundary interval between the retention elements H1 and H2 leads to an advantage in that the time length of the combination element PC (furthermore, the time length of the driving period of time TU) can be made shorter.

### C: Modification Examples

The above-described embodiments can be variously modified. Specific modifications of the above-described embodiments will be hereinafter exemplified as modification examples. Any two or more modifications which are arbitrarily selected from among the following modification examples can be appropriately combined.

### (1) Modification Example 1

The total number of the ejection pulses PDs existing during the driving period of time TU, as well as the total number of the slight vibration pulses PVs existing during the driving period of time TU, can be arbitrarily changed. For example, as shown in FIG. 7, it is also possible to locate a plurality of the ejection pulses PDs (PD1 and PD2) and a plurality of the slight vibration pulses PVs (PV1 and PV2) during the driving period of time TU of the driving signal COM. Further, it is possible to arbitrarily determine an order in which the plurality of the ejection pulses PDs and the plurality of the slight vibration pulses PVs are to be aligned. Therefore, it is possible to adopt a configuration in which a plurality of the slight vibration pulses PVs are aligned posterior to alignment of a plurality of the ejection pulses PDs. However, from the foregoing viewpoint in which a vibration, which is transmitted to ink by each of the slight vibration pulses, is to be effectively utilized by allowing an interval between any two successive slight vibration pulses PVs to keep a sufficient time length with certainty, as shown in an example of FIG. 7, a configuration, in which the slight variation pulses PVs and the ejection pulses PDs are alternately aligned (PV1→PD1→PV2→PD2), is particularly suitable. In addition, in the example described above, a slight vibration is transmitted to the ink contained in the pressure chamber 42 twice during the driving period of time TU, but it is also possible to transmit a slight vibration to the ink contained therein three or more times during the period of time TU.

### (2) Modification Example 2

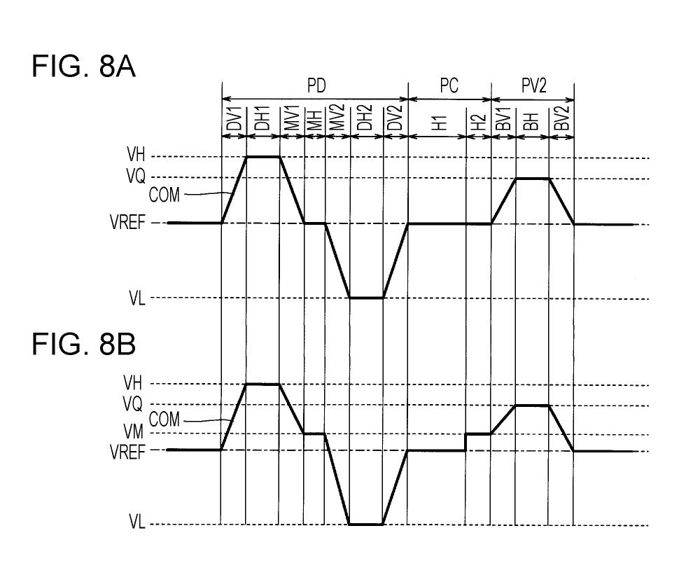

The intermediate electric potential VM of the ejection pulse PD is appropriately determined in accordance with respective target values of the weight and the rate of ink to be ejected from each ejection unit U having been supplied with the ejection pulse PD, and is not limited to an electric potential lower than the reference electric potential VREF. For example, in the second embodiment, it is possible to adopt a configuration in which, as shown in FIG. 8A, the electric potential of the retention element MH of the election pulse PD is set to the same electric potential as the reference electric potential VREF, as well as a configuration in which, as shown in FIG. 8B, the intermediate electric potential VM of the retention element MH of the election pulse PD is set to an electric potential higher than the reference electric potential VREF. As shown in respective examples of FIGS. 8A and 8B, the electric potential of the retention element H2 of the combination element PC (the start point of the slight vibration pulse PV2) is set to the same electric potential as that of the retention element MH, that is, an electric potential higher than or equal to the reference electric potential VREF.

### (3) Modification Example 3

In the second embodiment, an electric potential EP1 of the termination point of the slight ejection pulse PV1 (the termination point of the intermediate element MV1 of the election pulse PD) and an electric potential EP2 of the start point of the slight vibration pulse PV2 are set to the same electric potential (i.e., the intermediate electric potential VM), but the electric potential EP1 and the electric potential EP2 can be set to respective electric potentials which are different from each other. However, such a configuration, in which the electric potential EP1 of the termination point of the slight vibration pulse PV1 and the electric potential EP2 of the start point of the slight vibration pulse PV2 are different from each other, causes a discontinuous electric potential change of an electric potential applied to the piezoelectric element 44 at the start point of the slight vibration pulse PV2, and this discontinuous electric potential change thereof is likely to transmit an unexpected vibration to the ink contained in the pressure chamber 42. In the foregoing second embodiment, since the electric potential EP1 of the termination point of the slight ejection pulse PV1 and the electric potential EP2 of the start point of the slight vibration pulse PV2 are set to the same electric potential (i.e., the intermediate electric potential VM), the electric potential applied to the piezoelectric element 44 varies without any discontinuous electric potential change at points anterior to and posterior to the start point of the slight vibration pulse PV2. Therefore, there is an advantage in that it is possible to reduce the possibility of transmitting unexpected vibrations to the ink contained in the pressure chamber 42.

### (4) Modification Example 4

Waveforms of the election pulse PD and the slight vibration pulses PVs are not limited to those shown in the examples above. For example, it is possible to employ the slight vibration pulse PV whose electric potential moves in both directions of a higher electric potential and a lower electric potential relative to the reference electric potential VREF, as well as the ejection pulse PD whose electric potential moves only in one direction of a higher electric potential or a lower electric potential relative to the reference electric potential VREF. Further, in the first embodiment, it is possible to adopt a configuration in which the waveforms (the time lengths and electric potentials of the respective intervals) of the corresponding slight vibration pulses PVs (PV1 and PV2) are different from each other. Moreover, it is possible to appropriately omit any of the retention elements (AH, DH1, MH, DH2 and BH) of the driving signal COM.

In each of the embodiments above, a slight vibration is transmitted to the ink by increasing the pressure of the pressure chamber 42 subsequent to decrease of the pressure thereof, but it is also possible to transmit a slight vibration to the ink by decreasing the pressure of the pressure chamber 42 subsequent to increase of the pressure thereof. In addition, in each of the embodiments above, a configuration, in which the pressure of the pressure chamber 42 decreases along with a variation of the electric potential, which is supplied to the piezoelectric element 44 from the driving circuit 30, in a higher electric potential direction, has been described, but it is also possible to adopt a configuration in which the pressure of the pressure chamber 42 increases along with a variation of the electric potential, which is supplied to the piezoelectric element 44, in the higher electric-potential direction (i.e., a configuration in which the pressure of the pressure chamber 42 decreases along with a variation of the electric potential in a lower electric-potential direction).

### (5) Modification Example 5

In the second embodiment, the slight vibration pulse PV1 is generated from the ejection pulse PD, and further, in a configuration in which a plurality of the ejection pulses PDs are located during the driving period of time TU, the slight vibration pulse PV2 can be also generated from one of the ejection pulses. That is, a configuration in which all the slight vibration pulses PVs are extracted from the corresponding ejection pulses PDs can be realized. As understood from the description above, the second embodiment is comprehended as an embodiment having a configuration which allows part of intervals of the ejection pulse PD included in the driving signal COM to be applied as at least one slight vibration pulse PV.

### (6) Modification Example 6

In each of the embodiments described above, ejections and slight vibrations of ink during a period of time while the recording head 24 is located at an area over the surface of the recording paper 200 (i.e., during a printing period of time) have been described, and further, during a period of time while the recording head 24 is located out of the area over the surface of the recording paper 200 (i.e., during a non-printing period of time), operations similar to those during the printing period of time can be carried out. For example, it is possible to, immediately before the recording head 24 reaches the area over the surface of the recording paper 200 (i.e., immediately prior to ejection of ink onto the recording paper 200), transmit slight vibrations to the ink contained in the pressure chamber 42 in the same manner as or in a manner similar to that of the first and second embodiments.

### (7) Modification Example 7

In each of the embodiments described above, the printing apparatus 100, which is a serial type printing apparatus, and which causes the carriage 12 having the recording head 24 mounted thereon to move, has been described, and further, it is possible to apply the invention to the printing apparatus 100, which is a line type printing apparatus, and which includes a plurality of ejection units U (the nozzles 46) that are arrayed so as to be opposite to the entire region spreading in the width direction of the recording paper 200. The line type printing apparatus 100 performs recording of images on the recording paper 200 by causing the individual nozzles 46 included in the settled recording head 24 to eject liquid droplets onto the recording paper 200 in conjunction with transporting the recording paper 200. As understood from the description above, according to the prevention, it is unnecessary to inquire about whether the recording head 24 (each of the ejection unit Us) itself is movable or settled.

### (8) Modification Example 8

An element for changing the pressure inside the pressure chamber 42 (i.e., a pressure generation element) is not limited to the piezoelectric element 44. For example, it is also possible to employ an oscillating body, such as an electrostatic actuator. Further, the pressure generation element is not limited to an element which transmits mechanical vibrations to the pressure chamber 42. For example, it is also possible to employ a heater element (a heater) which changes the pressure inside the pressure chamber 42 by heating the pressure chamber 42 to allow air bubbles to arise inside the pressure chamber 42. That is, the pressure generation element is comprehended as an element which changes the pressure inside the pressure chamber 42, and it is unnecessary to inquire about a method (for example, the piezoelectric method and the thermal method) and a configuration for changing the pressure.

### (9) Modification Example 9

The printing apparatus 100 according to each of the embodiments described above can be employed in various devices, such as a plotter, a facsimile machine and a copy machine. Naturally, the application of the liquid ejecting apparatus according to the invention is not limited to printing of images. For example, a liquid ejecting apparatus for ejecting liquid solutions for respective color materials is utilized as a manufacturing apparatus for forming color filters for liquid crystal display apparatuses. Further, for example, a liquid ejecting apparatus for ejecting conductive materials in a liquid condition is utilized as an electrode manufacturing apparatus for forming electrodes for display apparatuses, such as an organic electroluminescence (EL) display apparatus and a field emission display (FED) apparatus. Moreover, a liquid ejecting apparatus for ejecting liquid solutions for living organic materials is utilized as a tip manufacturing apparatus for manufacturing biotips. Further, an object subjected to ejection of liquid (a striking object) is different depending on an application of a corresponding liquid ejecting apparatus. For example, the striking object of the printing apparatus 100 described above is the recording paper 200, and in the case where a liquid ejecting apparatus is used for manufacturing a display apparatus, for example, a substrate included in the display apparatus corresponds to the striking object.

What is claimed is:

1. A liquid ejecting apparatus, comprising:
an ejection unit which includes a pressure chamber filled with liquid and a pressure generation element causing a pressure inside the pressure chamber to vary, and which ejects the liquid through a nozzle of the pressure chamber in accordance with the variation of the pressure inside the pressure chamber;
a driving signal generation section which generates a driving signal whose electric potential varies with a cycle of a driving period of time;
a driving section which causes the liquid to eject through the nozzle by supplying the pressure generation element with an ejection waveform included in the driving signal, and which transmits a slight vibration to the liquid contained in the pressure chamber a plurality of number of times during the driving period of time by supplying the pressure generation element with a plurality of slight vibration waveforms which is included during the driving period of time of the driving signal.

2. The liquid ejecting apparatus according to claim 1, wherein each of the plurality of slight vibration waveforms is a waveform different from the ejection waveform.

3. The liquid ejecting apparatus according to claim 2, wherein the driving signal includes a first slight vibration waveform and a second slight vibration waveform as the plurality of slight vibration waveforms during every driving period of time, and the ejection waveform is located between the first slight vibration waveform and the second slight vibration waveform.

4. The liquid ejecting apparatus according to claim 2, wherein the driving signal includes a plurality of ejection waveforms and a plurality of slight vibration waveforms during every driving period of time, and the ejection waveforms and the slight vibration waveforms are alternately located.

5. The liquid ejecting apparatus according to claim 1, wherein the driving section supplies the pressure generation element with part of intervals of the ejection waveform included in the driving signal as at least one of the plurality of slight vibration waveforms.

6. The liquid ejecting apparatus according to claim 5, wherein the ejection waveform includes,
a first variation element during which an electric potential varies in a first direction starting from a reference electric potential,
a first intermediate element during which, after having varied along the first variation element, the electric potential varies in a second direction opposite to the first direction to an intermediate electric potential,
a second intermediate element during which, after having varied along the first intermediate element, the electric potential varies in the second direction, and
a second variation element during which, after having varied along the second intermediate element, the electric potential varies in the first direction to the reference electric potential,
wherein the driving section supplies the pressure generation element with an interval corresponding to the elements of the ejection waveform, which are located prior to a start point of the second intermediate element, as a first slight vibration waveform of the plurality of slight vibration waveforms.

7. The liquid ejecting apparatus according to claim 6, wherein a second slight vibration waveform of the plurality of slight vibration waveforms, which is supplied to the pressure generation element after the supply of the first slight vibration waveform, includes a third variation element during which an electric potential varies in the first direction from the intermediate electric potential, and a fourth variation element during which, after having varied along the third variation element, the electric potential varies in the second direction.

8. The liquid ejecting apparatus according to claim 7, wherein the intermediate electric potential is an electric potential of a point shifted in the second direction from the reference electric potential.

9. A control method for a liquid ejecting apparatus which includes a pressure chamber filled with liquid and a pressure generation element causing a pressure inside the pressure chamber to vary, and which ejects the liquid through a nozzle of the pressure chamber in accordance with the variation of the pressure inside the pressure chamber, the control method comprising:
generating a driving signal whose electric potential varies with a cycle of a driving period of time;
supplying the pressure generation element with an ejection waveform included in the driving signal to eject the liquid through the nozzle; and
supplying the pressure generation element with a plurality of slight vibration waveforms included in the driving signal during the driving period of time to transmit a slight vibration to the liquid contained in the pressure chamber a plurality of number of times during the driving period of time.
